(19) United States
(12) Patent Application Publication
(10) Pub. No.: US 2016/0351906 A1
(43) Pub. Date: Dec. 1, 2016

(54) NONAQUEOUS-ELECTROLYTE SECONDARY-BATTERY NEGATIVE ELECTRODE

(71) Applicant: SANYO ELECTRIC CO., LTD., Daito-shi, Osaka (JP)

(72) Inventors: Mai Yokoi, Tokushima (JP); Satoshi Yamamoto, Osaka (JP); Yasunobu Iwami, Tokushima (JP); Toshiyuki Nakamori, Tokushima (JP); Taizou Sunano, Osaka (JP)

(73) Assignee: Sanyo Electric Co., Ltd., Daito-shi, Osaka (JP)

(21) Appl. No.: 15/114,934

(22) PCT Filed: Jan. 20, 2015
(86) PCT No.: PCT/JP2015/000209

§ 371 Date: Jul. 28, 2016

(30) Foreign Application Priority Data
Jan. 31, 2014 (JP) 2014-016562

(51) Int. Cl. H01M 4/62; H01M 4/134; H01M 10/0525; H01M 4/38; H01M 4/525; H01M 4/587; H01M 4/133; H01M 4/36

(52) U.S. Cl. CPC H01M 4/62; H01M 4/133; H01M 4/134; H01M 4/364; H01M 4/386; H01M 4/525; H01M 4/587; H01M 4/622; H01M 4/623; H01M 4/625; H01M 10/0525

(57) ABSTRACT

The high-temperature storage characteristics of nonaqueous electrolyte secondary batteries are improved. A negative electrode for nonaqueous electrolyte secondary batteries includes a negative electrode collector and a negative electrode mixture layer. The negative electrode mixture layer contains silicon-containing particles, graphite particles, and carboxymethyl cellulose ammonium salt, and the amount of NH₃ in the negative electrode mixture layer is 350 μg or less per g of the negative electrode mixture layer. The silicon-containing particles preferably have a conductive carbon material layer with which at least part of the surfaces thereof is covered. The silicon-containing particles preferably include SiO_{X} (0.5≦X≦1.5) particles.

### TECHNICAL FIELD

The present invention relates to a negative electrode for nonaqueous electrolyte secondary batteries.

### BACKGROUND ART

As an attempt to improve the energy density and output of lithium-ion batteries, investigations have been made into the use of negative electrode active materials such as metallic materials that can be alloyed with lithium, such as silicon, germanium, tin, and zinc, and oxides of these metals as an alternative to carbonaceous materials such as graphite.

Negative electrode active materials made from metallic materials that can be alloyed with lithium and/or oxides of these metals are known to experience a loss of cycle characteristics during charging and discharge because of the expansion and contraction of the negative electrode active materials. PTL 1 below proposes a negative electrode for nonaqueous electrolyte secondary batteries that contains a composite of a material composed of elements including Si and O and a carbon material as well as a graphitic carbon material as negative electrode active materials.

### CITATION LIST

### Patent Literature

PTL 1: Japanese Published Unexamined Patent Application No. 2010-212228

### SUMMARY OF INVENTION

### Technical Problem

The nonaqueous electrolyte secondary battery of PTL 1 has the disadvantage of producing gas when stored at high temperatures.

### Solution to Problem

To solve this problem, a negative electrode according to the present invention for nonaqueous electrolyte secondary batteries, which includes a negative electrode collector and a negative electrode mixture layer, is characterized in that the negative electrode mixture layer contains silicon-containing particles, graphite particles, and carboxymethyl cellulose ammonium salt and that the amount of NH₃ in the negative electrode mixture layer is 350 μg or less per g of negative electrode mixture.

### Advantageous Effects of Invention

Nonaqueous electrolyte secondary batteries utilizing the negative electrode according to the present invention for nonaqueous electrolyte secondary batteries offer controlled production of gas during high-temperature storage because of a low ammonium concentration in the negative electrode mixture layer.

### BRIEF DESCRIPTION OF DRAWINGS

FIG. 1 is a cross-sectional view of a negative electrode as an example of an embodiment of the present invention.

FIG. 2 is a graphical representation of the results of Experiments 1 to 4.

### DESCRIPTION OF EMBODIMENTS

The following describes an embodiment of the present invention in detail.

The drawing referenced in the description of the embodiment is a schematic, and the relative dimensions and other details of the illustrated components are not necessarily to scale. The following description should be considered when any specific relative dimensions or other details of a component are determined.

A nonaqueous electrolyte secondary battery as an example of an embodiment of the present invention includes a positive electrode that contains a positive electrode active material, a negative electrode that contains a negative electrode active material, a nonaqueous electrolyte that contains a nonaqueous solvent, and a separator. An example of a nonaqueous electrolyte secondary battery is a structure in which an electrode body composed of positive and negative electrodes wound with a separator therebetween and a nonaqueous electrolyte are held together in a sheathing body.

### [Positive Electrode]

The positive electrode is preferably composed of a positive electrode collector and a positive electrode active material layer on the positive electrode collector. The positive electrode collector is, for example, a conductive thin-film body, in particular a foil of a metal or alloy that is stable in the range of positive electrode potentials, such as aluminum, or a film that has a surface layer of a metal such as aluminum. The positive electrode active material layer preferably contains a conductive material and a binder in addition to the positive electrode active material.

The positive electrode active material contains an oxide that contains lithium and one or more metallic elements M, and the one or more metallic elements M include at least one selected from a group including cobalt and nickel. Preferably, the oxide is a lithium transition metal oxide. The lithium transition metal oxide may contain non-transition metals, such as Mg and Al. Specific examples include lithium transition metal oxides such as lithium cobalt oxide, Ni—Co—Mn, Ni—Mn—Al, and Ni—Co—Al. The positive electrode active material can be one of these, and can also be a mixture of two or more.

### [Negative Electrode]

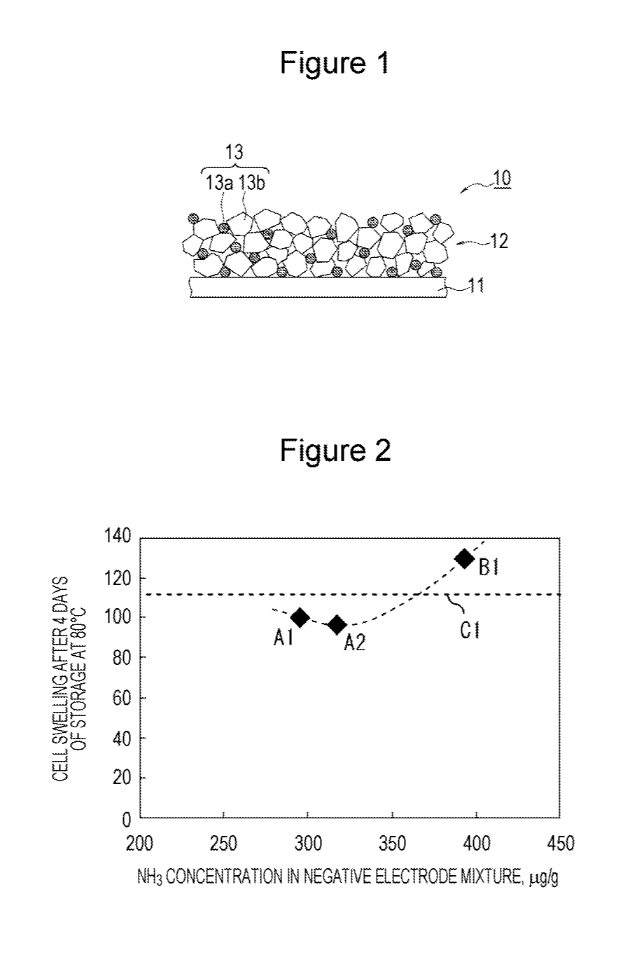

As illustrated in FIG. 1, the negative electrode 10 preferably includes a negative electrode collector 11 and a negative electrode mixture layer 12 on the negative electrode collector 11. The negative electrode collector 11 is, for example, a conductive thin-film body, in particular a foil of a metal or alloy that is stable in the range of negative electrode potentials, such as copper, or a film that has a surface layer of a metal such as copper. The negative electrode mixture layer contains a negative electrode active material and carboxymethyl cellulose ammonium salt (CMC ammonium salt), preferably with a binder. The binder is preferably a material such as styrene-butadiene rubber (SBR) or polyimide.

The negative electrode active material 13 includes a negative electrode active material 13a that is silicon-containing particles and a negative electrode active material 13b that is graphite-containing particles. The negative electrode active material 13a preferably contains SiO_{X} (preferably 0.5≦X≦1.5), Si, or a Si alloy. Examples of Si alloys include solid solutions of silicon in one or more other elements, intermetallic compounds of silicon and one or more other elements, and eutectic alloys of silicon and one or more other elements. It is particularly preferred to use SiO_{X} particles.

The amount of NH₃ in the negative electrode mixture layer is 350 μg or less per g of negative electrode mixture layer. Scarcity of NH₃ in the negative electrode mixture layer, or a low ammonium concentration in the negative electrode mixture layer, leads to reduced production of gas through the side reaction between the CMC ammonium salt and Li during storage at high temperatures.

The amount of NH₃ in the negative electrode mixture layer is preferably 250 μg or more per g of negative electrode mixture layer. When NH₃ in the negative electrode mixture layer is less than 250 μg, the ammonium salt fails to coat the surfaces of the negative electrode active materials 13a and 13b uniformly. The consequent weakened bond between the active materials and between the active materials and the collector at the negative electrode leads to lower conductivity to electrons, affecting the capacity.

The NH₃ content of the negative electrode mixture layer varies according to the temperature, duration, and atmosphere selected for the heat treatment of the negative electrode. The heating atmosphere is preferably a vacuum. Heating at atmospheric pressure tends to be ineffective in reducing the NH₃ content of the negative electrode mixture layer. The heating temperature is preferably 120° C. or less. Heating at too high a temperature may denature the binder while reducing the NH₃ content of the negative electrode mixture layer. The degree of etherification of the CMC ammonium salt and the CMC ammonium salt content of the negative electrode mixture layer also influence the NH₃ content of the negative electrode mixture layer.

The degree of etherification of the CMC ammonium salt is from 0.6 to 1.4, more preferably from 0.6 to 1.0. A low degree of etherification often leads to high viscosity of the negative electrode slurry. High viscosity of the negative electrode slurry makes it difficult to mix the negative electrode active materials uniformly, and this tends to affect the capacity by weakening the adhesion between the negative electrode active materials and between the negative electrode active materials and the collector. A high degree of etherification often leads to a high NH₃ content concentration of the negative electrode mixture layer, which tends to cause increased gas production during storage at high temperatures.

The amount of CMC ammonium salt in the negative electrode mixture layer is preferably from 0.8% to 2.0% by mass of the total mass of the negative electrode mixture layer. A small mass of CMC ammonium salt relative to the total mass of the negative electrode mixture layer affects the adhesion between the negative electrode active materials and between the negative electrode active materials and the collector. A large mass of CMC ammonium salt affects the capacity by inhibiting the diffusion of Li⁺ into SiO_{X}.

The ratio by mass of the carboxymethyl cellulose ammonium salt to the binder in the negative electrode mixture layer is preferably from 35:65 to 65:35. Any proportion of carboxymethyl cellulose ammonium salt outside this range makes it difficult to mix the negative electrode active materials uniformly, thereby affecting the adhesion between the negative electrode active materials and between the negative electrode active materials and the collector.

The negative electrode active material 13a preferably has a conductive carbon material layer with which at least part of the surface thereof is covered. When SiO_{X} particles are used as the negative electrode active material 13a, it is particularly preferred that the SiO_{X} particles have a conductive carbon material layer with which at least part of the surfaces thereof is covered. The conductive carbon material is preferably one that is of low crystallinity and highly permeable to the electrolytic solution. Such a carbon material is formed from, for example, coal tar, tar pitch, naphthalene, anthracene, or phenanthroline, preferably coal-based coal tar or petroleum tar pitch, as the starting material.

The SiO_{X} particles preferably have their surfaces 50% or more and 100% or less, preferably 100%, covered with carbon. In the present invention, having SiO_{X} surfaces covered with carbon means that the surfaces of the SiO_{X} particles are covered with carbon coatings with a thickness of at least 1 nm when cross-sections of the particles are observed using SEM. In the present invention, having SiO_{X} surfaces 100% covered with carbon means that substantially 100% of the surfaces of the SiO_{X} particles are covered with carbon coatings with a thickness of at least 1 nm when cross-sections of the particles are observed using SEM. Substantially 100% is intended to include not only 100% but also any percentage practically regarded as 100%. The thickness of the carbon coatings is preferably from 1 to 200 nm, more preferably from 5 to 100 nm. Too thin carbon coatings lead to low conductivity, and too thick carbon coatings tend to affect the capacity by inhibiting the diffusion of Li⁺ into SiO_{X}.

For the SiO_{X} particles, it is preferred that the full width at half maximum of the near-1360 cm⁻¹ peak in a Raman spectrum obtained by Raman spectroscopy be 60 cm⁻¹ or more and 250 cm⁻¹ or less, more preferably from 120 cm⁻¹ to 170 cm⁻¹.

If there is a peak at 1360 cm⁻¹, the near-1360 cm⁻¹ peak represents that peak. If there is no peak at 1360 cm⁻¹, the near-1360 cm⁻¹ peak represents the peak closest to 1360 cm⁻¹ on a peak top basis. The near-1360 cm⁻¹ peak in a Raman spectrum is hereinafter referred to as “the specified Raman peak.”

The specified Raman peak of the SiO_{X} particles can be used to examine the crystallinity of the carbon material that the carbon coatings are formed from. Specifically, when the full width at half maximum of the specified Raman peak of the SiO_{X} particles is as large as 100 cm⁻¹ or more, the carbon material that the carbon coatings are formed from is of low crystallinity.

Carbon coatings of low crystallinity have many OH groups on their surfaces. When the full width at half maximum of the specified Raman peak falls within the above range, the OH groups on the surfaces of the carbon coatings for SiO_{X} are likely to bind with NH₄ groups in the CMC ammonium salt. The consequent release of NH₃ in the form of gas reduces the NH₃ content of the negative electrode mixture layer, lowering the production of gas during storage at high temperatures. The associated decrease of the OH groups on the surfaces of the carbon coatings for SiO_{X}, which are the cause of H₂ gas production during storage at high temperatures, further reduces the production of gas during high-temperature storage.

Commercial Raman spectrometers can be used to measure the Raman spectrum of the SiO_{X} particles. An example of a preferred Raman spectrometer is HORIBA “LaabRAM ARAMIS” laser Raman microscope.

Carbon coatings with such a characteristic specified Raman peak as described above are produced by, for example, immersing the SiO_{X} particles as the substrate in a solution of a material such as coal tar and processing the particles at high temperatures in an inert atmosphere. It is preferred that the heating temperature be approximately from 900° C. to 1100° C.

The average particle diameter of the negative electrode active material particles 13a is preferably from 1 to 15 pm, more preferably 4 to 10 pm, for the purpose of a high capacity. The “average particle diameter” herein refers to the particle diameter in a particle size distribution measured using laser diffraction at which the integrated volume is 50% (the volume-average particle diameter; Dv₅₀). The Dv₅₀ can be measured using, for example, HORIBA “LA-750.” Too small particle diameters, which mean large surface areas of the particles and therefore lead to increased reaction with the electrolyte, tend to affect the capacity. Too large particle diameters, which prevent Li⁺ from diffusing into the near center of SiO_{X}, tend to affect the capacity and load characteristics.

The average particle diameter of the negative electrode active material particles 13b is preferably from 15 to 25 pm.

The ratio by mass of the negative electrode active material particles 13a to the negative electrode active material particles 13b is from 1:99 to 20:80, more preferably 3:95 to 10:90. When the proportion of the negative electrode active material particles 13a to the total mass of the negative electrode active materials is less than 1% by mass, the negative electrode expands and contracts only to a small extent and thus does not sufficiently benefit from the effect of improved adhesion. When the proportion of the silicon-containing particles to the total mass of the negative electrode active materials is more than 20% by mass, the characteristics of the battery tend to be low because the negative electrode expands and contracts so greatly that the adhesion is insufficient.

### [Nonaqueous Electrolyte]

The electrolytic salt for the nonaqueous electrolyte can be, for example, LiCLO₄, LiBF₄, LiPF₆, LiAlCl₄, LiSbF₆, LiSCN, LiCF₃SO₃, LiCF₃CO₂, LiAsF₆, LiB₁₀Cl₁₀, a lower aliphatic carboxylic acid lithium salt, LiCl, LiBr, LiI, chloroborane lithium, a boric acid salt, or an imide salt. LiPF₆ is particularly preferred because of its ionic conductivity and electrochemical stability. Electrolytic salts can be used alone, and a combination of two or more electrolytic salts can also be used. These electrolytic salts are preferably contained in a proportion of 0.8 to 1.5 mol per L of the nonaqueous electrolyte.

The solvent for the nonaqueous electrolyte can be, for example, a cyclic carbonate, a linear carbonate, or a cyclic carboxylate. Examples of cyclic carbonates include propylene carbonate (PC), ethylene carbonate (EC), and fluoroethylene carbonate (FEC). Examples of linear carbonates include diethyl carbonate (DEC), ethyl methyl carbonate (EMC), and dimethyl carbonate (DMC). Examples of cyclic carboxylates include γ-butyrolactone (GBL) and γ-valerolactone (GVL). Examples of linear carboxylates include methyl propionate (MP) fluoromethyl propionate (FMP). Nonaqueous solvents can be used alone, and a combination of two or more nonaqueous solvents can also be used.

### [Separator]

The separator is an ion-permeable and insulating porous sheet. Specific examples of porous sheets include microporous thin film, woven fabric, and nonwoven fabric. The separator is preferably made of a polyolefin, such as polyethylene or polypropylene.

### EXAMPLES

The following describes the present invention in more detail by providing some examples. However, the present invention is not limited to these examples.

### Example 1

### Experiment 1

### Preparation of Positive Electrode

Lithium cobalt oxide, acetylene black (HS100, Denki Kagaku Kogyo K.K.), and polyvinylidene fluoride (PVdF) were weighed out and mixed to a ratio by mass of 95.0:2.5:2.5, and N-methyl-2-pyrrolidone (NMP) as a dispersion medium was added. Positive electrode slurry was prepared by stirring the mixture using a mixer (T.K. HIVIS MIX, PRIMIX Corporation). This positive electrode slurry was applied to both sides of an aluminum foil as a positive electrode collector, followed by drying and rolling with a roller. In this way, a positive electrode was prepared as a positive electrode collector with a positive electrode mixture layer on each side thereof. The packing density in the positive electrode mixture layer was 3.60 g/ml.

### [Preparation of Negative Electrode]

### [Preparation of Negative Electrode Active Material Particles B1]

A mixture of Si and SiO₂ in a 1:1 molar ratio was heated to 800° C. under reduced pressure. The SiO_{X} gas generated through heating was cooled and crystallized into polycrystalline SiO_{X} blocks, and these polycrystalline SiO_{X} blocks were milled and classified. In this way, SiO_{X} particles with an average particle diameter of 5.8 pm (hereinafter referred to as “mother particles A1”) were prepared. The average particle diameter of mother particles A1 is a measurement obtained using HORIBA “LA-750” with water as dispersant (the same applies hereinafter).

The surfaces of mother particles A1 were then coated with layers of a conductive carbon material. The coating layers were formed using coal-based coal tar as carbon source to have an average thickness of 50 nm and to make 5% by mass (mass of the coating layers/mass of negative electrode active material particles B1). The coal-based coal tar was in the form of solution in tetrahydrofuran (a 25:75 ratio by mass), and this solution of coal-based coal tar was mixed with mother particles A1 to a ratio by mass of 2:5. The resulting mixture was dried at 50° C. and heated at 1000° C. in an inert atmosphere. In this way, particles B1 composed of mother particles A1 and carbon coatings on their surfaces were prepared (hereinafter referred to as “negative electrode active material particles B1).

A mixture of negative electrode active material particles B1 and graphite (average primary particle diameter: 20 pm) in a 3:97 ratio by mass was used as negative electrode active material. Negative electrode mixture slurry was prepared by mixing this negative electrode active material, carboxymethyl cellulose ammonium salt (CMC ammonium salt) styrene butadiene rubber to a ratio by mass of 98:1:1, together with an appropriate amount of water, using a mixer. This negative electrode mixture slurry was applied to both sides of a 10-μm-thick copper foil as a negative electrode collector sheet, followed by drying and rolling. The packing density in the negative electrode active material layer was 1.60 g/ml. The CMC ammonium salt used was one with (a degree of etherification of 0.8).

This negative electrode slurry was then uniformly applied to both sides of a copper foil as a negative electrode collector, with the mass of the resulting negative electrode mixture layer per m² being 190 g. These coatings were dried in air at 105° C. and rolled using a roller. In this way, a negative electrode was prepared as a negative electrode collector with a negative electrode mixture layer on each side thereof. The packing density in the negative electrode mixture layer was 1.60 g/ml.

### (Measurement of Raman Spectrum)

A Raman spectrum (the specified Raman peak) of negative electrode active material particles B1 was acquired, and the full width at half maximum of the specified Raman peak was determined. The full width at half maximum of the specified Raman peak was 134 cm⁻¹.

### [Preparation of Nonaqueous Electrolytic Solution]

A nonaqueous electrolytic solution was prepared by adding 1.0 mole/liter of lithium hexafluorophosphate (LiPF₆) to a solvent mixture composed of ethylene carbonate (EC) and diethyl carbonate (DEC) mixed in a 3:7 ratio by volume.

### [Assembly of Battery]

A wound electrode body was prepared by attaching a tab to each of the electrodes and winding the positive and negative electrodes into a spiral with the separator therebetween and the tabs at the outermost periphery. This electrode body was inserted into a sheathing body composed of laminated aluminum sheets. After 2 hours of drying in a vacuum at 105° C., the nonaqueous electrolytic solution was injected, and the opening of the sheathing body was sealed. In this way, battery A1 was assembled. The design capacity of battery A1 is 800 mAh.

### (Measurement of NH₃ Content of Negative Electrode Mixture Layer)

The negative electrode prepared in Preparation of Negative Electrode above was dried in a vacuum at 105° C. for 2 hours. The negative electrode mixture layer was then removed from the negative electrode, and the removed negative electrode mixture layer was heated at 200° C. in a nitrogen stream for 30 minutes. The gas generated through heating was passed through 0.05 moles/liter dilute sulfuric acid to collect NH₄⁺ ions. Based on the collected NH₄⁺ ions, the NH₃ content was measured using Nippon Dionex “ICS-3000” ion chromatograph. The NH₃ content of the negative electrode mixture layer was 295 μg per g of the negative electrode mixture layer.

### Experiment 2

Battery A2 was produced in the same way as battery A1 except that in the assembly of the battery, the electrode body in the sheathing body was dried in a vacuum for 2 hours at 85° C. After the negative electrode prepared in Preparation of Negative Electrode was dried in a vacuum at 105° C. for 2 hours, the NH₃ content of the negative electrode mixture layer was 317 μg per 1 g of the negative electrode mixture layer.

### Experiment 3

Battery B1 was produced in the same way as battery A1 except that in the assembly of the battery, the electrode body in the sheathing body was dried in a vacuum for 2 hours at 65° C. After the negative electrode prepared in Preparation of Negative Electrode was dried in a vacuum at 65° C. for 2 hours, the NH₃ content of the negative electrode mixture layer was 393 μg per 1 g of the negative electrode mixture layer.

### Experiment 4

Battery C1 was produced in the same way as battery A1 except that in the assembly of the battery, the CMC ammonium salt was changed to carboxymethyl cellulose sodium salt (CMC sodium salt). For battery C1, the negative electrode mixture layer contained no NH₃.

### Experiment

Each of these batteries was stored under the conditions below and tested for the percent swelling (%) according to formula (1) below. The results are summarized in Table 1 and FIG. 2.

Constant-current charging was performed at a 1.0-it (800-mA) current until the battery voltage reached 4.2 V. Constant-voltage charging was then performed at a voltage of 4.2 V until the current reading reached 0.05 it (40 mA). After a halt of 10 minutes, constant-current discharge was performed at a 1.0-it (800-mA) current until the battery voltage reached 2.75 V.

The battery that completed the first cycle of charging and discharge was then subjected to a constant-current charging at a 1.0-it (800-mA) current to a battery voltage of 4.2 V, a constant-voltage charging at a voltage of 4.2 V to a current reading of 0.05 it (40 mA), and 4 days of storage at 80° C.

### [Formula Used to Calculate Percent Battery Swelling (%)]

Percent battery swelling(%)=((Battery thickness after storage−Battery thickness before storage)/Battery thickness before storage)×100 (1)

Each battery thickness is a measurement obtained using a micrometer.

In Table 1, the battery swellings displayed are relative percent swellings of the batteries determined with the percent battery swelling of battery A1 as 100.

TABLE 1

| | | | NH₃ | Battery |
|---|---|---|---|---|
| | | | concentration | swelling |
| | | Negative | in negative | after 4 |
| | | electrode | electrode | days of |
| | Kind of | active | mixture | storage |
| Battery | CMC | materials | (μg/g) | at 80° C. |
| A1 | Ammonium salt | SiOₓ/Graphite | 295 | 100 |
| A2 | Ammonium salt | SiOₓ/Graphite | 317 | 96 |
| B1 | Ammonium salt | SiOₓ/Graphite | 393 | 130 |
| C1 | Sodium salt | SiOₓ/Graphite | — | 112 |

As is clear from Table 1, when silicon-containing particles and graphite particles were used as negative electrode active materials, battery swelling during the high-temperature storage was reduced more greatly with CMC ammonium salt than with CMC sodium salt excluding the case in which the NH₃ content per g of negative electrode mixture was 393 μg/g. This can be explained as follows.

For the NH₄ group of CMC ammonium salt, NH₃ is released as gas after binding with OH groups on the surfaces of carbon coatings on the silicon-containing particles. It was presumably because of this that battery B1, in which the ammonium concentration in the negative electrode mixture layer was high, produced a large amount of gas during the high-temperature storage compared with batteries A1 and A2, in which the ammonium concentration in the negative electrode mixture layer was low.

The Na group of CMC sodium salt is not released as gas and remains in the negative electrode mixture even after binding with the aforementioned OH groups. This residual Na compound in the negative electrode mixture, however, reacts with OH groups in the electrolytic solution to produce Hz gas. It was presumably because of this that battery C1, which incorporated CMC sodium salt, produced a large amount of gas during the high-temperature storage compared with batteries A1 and A2.

FIG. 2 suggests that the anti-swelling effectiveness of the use of CMC ammonium salt in negative electrodes that utilize silicon-containing particles and graphite particles as negative electrode active materials depends on the NH₃ content of the negative electrode mixture layer. In other words, there is an ideal range of the NH₃ content of the negative electrode mixture layer for the development of this anti-swelling effect.

When NH₃ in the negative electrode mixture layer is abundant, or the ammonium concentration in the negative electrode mixture layer is high, as stated, NH₃ gas is readily produced. When NH₃ in the negative electrode mixture layer is scarce, or the ammonium concentration in the negative electrode mixture layer is low, the adhesion between particles of the negative electrode active materials and between the negative electrode active material layer and the collector is weak, and this causes a large amount of Li to remain in or accumulate atop the active materials. In such a case, the gas production during high-temperature storage tends to be large because of the side reaction between the residual or accumulating Li and the electrolytic solution.

According to FIG. 2, this anti-swelling effect is expected to be obtained when the NH₃ content of the negative electrode mixture layer is from 280 to 350 μg/g.

### Reference Example

### Experiment 5

Battery R1 was produced in the same way as battery A1 except that in the preparation of the negative electrode, graphite was the only negative electrode active material used.

### Experiment 7

Battery R2 was produced in the same way as battery A1 except that in the preparation of the negative electrode, graphite was the only negative electrode active material used, and the CMC ammonium salt was changed to CMC sodium salt.

### Experiment

The percent swelling (%) was determined in the same way as in Example 1, and the discharge capacity of the negative electrode was measured under the conditions below. The negative electrodes in batteries A1, R1, and R2 above and metallic lithium foils were wound into spiral electrode bodies with lead terminals attached thereto and separators interposed therebetween. These electrode bodies were inserted into aluminum laminates as battery sheathing bodies, and the aforementioned nonaqueous electrolytic solution was injected to them. Test batteries were obtained in this way.

Constant-current charging was performed at a 0.15-it (7-mA) current until the battery voltage reached 0.0 V. After a halt of 10 minutes, constant-current discharge was performed at a 0.1-it (7-mA) current until the battery voltage reached 1.0 V. The discharge capacity was measured thereafter. The results are summarized in Table 2.

TABLE 2

| | | | | Battery |
|---|---|---|---|---|
| | | | | swelling |
| | | Negative | | after 4 |
| | | electrode | Discharge | days of |
| | Kind of | active | capacity | storage |
| Battery | CMC | material(s) | (mAh/g) | at 80° C. |
| A1 | Ammonium | SiOₓ/Graphite | 381 | 100 |
| | salt | | | |
| R1 | Ammonium | Graphite | 359 | 96 |
| | salt | | | |
| R2 | Sodium salt | Graphite | 358 | 22 |

As is clear from Table 3, when graphite was the only negative electrode active material used, unlike in the case in which silicon-containing particles and graphite particles were used as negative electrode active materials, battery swelling during the high-temperature storage was reduced more greatly with CMC sodium salt in the negative electrode mixture layer than with CMC ammonium salt. When the negative electrode mixture layer contains CMC ammonium salt, the inside of the negative electrode mixture is poorly permeable to the electrolytic solution, and such poor permeability prevents Li from taking part in charge and discharge cycles and makes it separate out. Presumably, these Li precipitates react with the electrolyte to increase the production of gas during storage at high temperatures. When CMC sodium salt is used in the negative electrode mixture layer, the inside of the negative electrode mixture is more permeable to the electrolyte than in the case in which CMC ammonium salt is used, and presumably this limits the production of gas during storage at high temperatures.

### REFERENCE SIGNS LIST

10 Negative electrode
11 Negative electrode collector
12 Negative electrode mixture layer
13, 13a, 13b Negative electrode active material

1. A negative electrode for a nonaqueous electrolyte secondary battery, the negative electrode comprising a negative electrode collector and a negative electrode mixture layer, wherein:
the negative electrode mixture layer contains silicon-containing particles, graphite particles, and carboxymethyl cellulose ammonium salt; and
an amount of NH₃ in the negative electrode mixture layer is 350 μg or less per g of the negative electrode mixture layer.

2. The negative electrode according to claim 1 for a nonaqueous electrolyte secondary battery, wherein the silicon-containing particles have a conductive carbon material layer with which at least part of surfaces thereof is covered.

3. The negative electrode according to claim 1 for a nonaqueous electrolyte secondary battery, wherein the silicon-containing particles include SiO_{X} (0.5≦X≦1.5) particles.

4. The negative electrode according to claim 3 for a nonaqueous electrolyte secondary battery, wherein in a Raman spectrum of the SiO_{X} particles obtained by Raman spectroscopy, a near-1360 cm⁻¹ peak has a full width at half maximum of 60 cm⁻¹ or more and 250 cm⁻¹ or less.
